(19) United States
(12) Patent Application Publication
(10) Pub. No.: US 2019/0073069 A1
(43) Pub. Date: Mar. 7, 2019

(54) NON IN-CELL TOUCH DISPLAY APPARATUS AND TOUCH DETECTION METHOD THEREOF

(71) Applicant: Au Optronics Corporation, Hsinchu (TW)

(72) Inventors: Szu-Che Yeh, Hsinchu (TW); Chi-Cheng Chen, Hsinchu (TW); Gui-Wen Liu, Hsinchu (TW); Feng-Ming Hsu, Hsinchu County (TW)

(73) Assignee: Au Optronics Corporation, Hsinchu (TW)

(21) Appl. No.: 15/826,730

(22) Filed: Nov. 30, 2017

(30) Foreign Application Priority Data
Sep. 5, 2017 (TW) 106130261

(51) Int. Cl. G06F 3/041; G06F 3/0354

(52) U.S. Cl. CPC G06F 3/0412; G06F 3/0416; G06F 2203/04108; G06F 2203/04106; G06F 3/03545

(57) ABSTRACT

A non in-cell touch display apparatus and a touch detection method thereof are provided. The touch detection method includes: dividing a vertical scanning time period into at least one physical scanning time period and at least one virtual scanning time period; driving at least one physical gate line according to a first clock signal during each of the at least one physical scanning time period, and driving at least one virtual gate line according to a second clock signal during each of the at least one virtual scanning time period; operating a first type touch detection during the at least one physical scanning time period, and operating a second type touch detection during the at least one virtual scanning time period.

### CROSS-REFERENCE TO RELATED APPLICATION

This application claims the priority benefit of Taiwan application serial no. 106130261, filed on Sep. 5, 2017. The entirety of the above-mentioned patent application is hereby incorporated by reference herein and made a part of this specification.

### BACKGROUND OF THE INVENTION

### 1. Field of the Invention

The invention relates to a non in-cell touch display apparatus, particularly a non in-cell touch display apparatus performing a touch detection method, wherein a driving signal of a display apparatus complies with different signal to noise ratio (SNR) demands at different timing and operating frequencies.

### 2. Description of Related Art

With the advancement of touch technologies, people use touch applications at different places in their daily lives, such as ATMs, mobile phones, laptops, medical equipment, and so on. In today's technology, the capacitive touch technologies are mainly applied to on-cell and in-cell) touch panels as well as to non in-cell touch panels.

In the non in-cell touch panel, a touch integrated circuit (IC) that performs a touch detection action needs to be synchronized with a display driver IC, so that the gate circuit can continuously transmit signals when the touch IC is operating. It is worth noting that different touch media require different signal to noise ratio environment. For example, when a touch medium is a stylus, a three-dimensional (3D) gesture, or a suspended finger, a relatively high signal to noise ratio environment is needed to accurately perform the touch detection action. On the contrary, there is no need for a relatively high signal to noise ratio environment when the touch medium is a normal hand gesture.

Based on the above, how to provide a relatively high signal to noise ratio environment during the touch detection action to perform a detection action of a stylus, a 3D hand gesture, or a suspended finger is an important topic for those skilled in the art.

### SUMMARY OF THE INVENTION

The invention provides a non in-cell touch display apparatus and a touch detection method thereof, which can provide different signal to noise ratio environment to perform touch detection actions of different signal to noise ratio demands.

The touch detection method provided in the invention is adapted to touch display panels. The touch detection method includes: dividing a vertical scanning time period into at least one physical scanning time period and at least one virtual scanning time period; driving at least one physical gate line according to a first clock signal during each of the at least one physical scanning time period, and driving at least one virtual gate line according to a second clock signal during each of the at least one virtual scanning time period; operating a first type touch detection during the at least one physical scanning time period and also operating a second type touch detection during the at least one virtual scanning time period.

The non in-cell touch display apparatus provided in the invention includes a touch display panel, a gate signal generator, and a controller. The gate signal generator is coupled to the touch display panel via a plurality of gate lines and drives the gate lines in accordance with the control signal. The controller is coupled to the gate signal generator. The controller is configured to divide a vertical scanning time period into at least one physical scanning time period and at least one virtual scanning time period, drive at least one physical gate line according to a first clock signal during the at least one physical scanning time period, drive at least one virtual gate line according to a second clock signal during the at least one virtual scanning time period, operate a first type touch detection during the at least one physical scanning time period, and also operate a second type touch detection during the at least one virtual scanning time period.

Based on the above, the vertical scanning time period is divided into the physical scanning time period and the virtual scanning time period as provided in the embodiments of the invention. In addition, respective touch detection actions are performed via clock signals of different frequencies during the physical scanning time period and the virtual scanning time period. Thereby, different signal to noise ratio environment may be provided during different time periods, and thereby different kinds of touch detection actions may be performed. As such, a favorable operating environment for performing the touch detection actions compliant with different signal to noise ratio demands may be provided.

To make the above features and advantages of the invention more comprehensible, several embodiments accompanied with drawings are described in detail as follows.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a flowchart illustrating a touch detection method according to an embodiment of the invention.

FIG. 2A is a time diagram illustrating a scanning time period according to an embodiment of the invention.

FIG. 2B is a schematic diagram illustrating a touch detection action according to an embodiment of the invention.

FIG. 3 illustrates time sequence of a driving signal according to an embodiment of the invention.

FIG. 4 is a schematic diagram illustrating a touch detection action according to an embodiment of the invention.

FIG. 5 is a schematic diagram illustrating a non in-cell touch display apparatus according to an embodiment of the invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

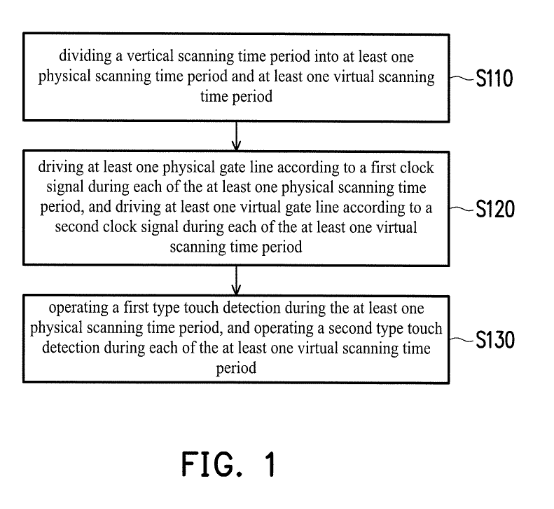

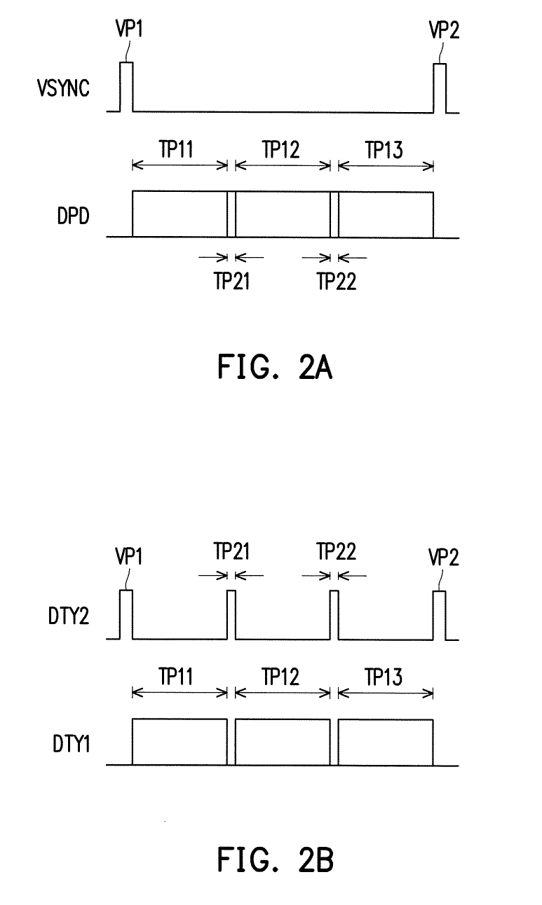

Referring to FIG. 1, which is a flowchart illustrating a touch detection method according to an embodiment of the invention, the touch detection method provided in the embodiment is adapted to a touch display panel, such as a non incell touch display panel, wherein in step S110 a vertical scanning time period is divided into one or a plurality of physical scanning time periods and one or a plurality of virtual scanning time periods. Here, please also refer to FIG. 2A, which is a time diagram illustrating a scanning time period according to an embodiment of the invention, wherein via detecting two adjacent pulse waves VP1 and VP2 of a vertical synchronized signal VSYNC, the vertical scanning time period may be recognized, and physical gate lines and virtual gate lines on a touch display panel are sequentially scanned in one vertical scanning time period. Here, while a driving signal DPD is displayed, the time period of scanning a physical gate line may be defined as physical scanning time periods TP11-TP13, the time period of scanning a virtual gate line may be defined as virtual scanning time periods TP21-TP22. In FIG. 2A, the physical scanning time periods TP11-TP13 and the virtual scanning time periods TP21-TP22 are alternately arranged. Regarding the above, the number of the physical scanning time periods and the number of the virtual scanning time periods are merely exemplary and should not be limited to those described in this invention.

It is important to note here that the so-called physical gate lines are gate lines that are physically able to drive display pixels on the touch display panel, while the so-called virtual gate lines are gate lines of the display pixels that are not actually connected to the display pixels on the touch display panel. Based on the above, when the physical gate lines are driven, according to a driven sequence corresponding to the physical gate lines, the display data are supplied to the corresponding display pixels for a performing an image display operation. When the virtual gate lines are driven, the supply of display data to the physical display pixel is stopped, or a black screen is stopped to be updated.

As shown in FIG. 1 and FIG. 2B which is a schematic diagram illustrating a touch detection action according to an embodiment of the invention, through the physical scanning time periods TP11-TP13 and the virtual scanning time periods TP21-TP22 recognized in the step 110, detection driving signals DTY1 and DTY2 may be defined. In addition, based on the detection driving signals DTY1 and DTY2, in step S120, one or a plurality of physical gate lines are driven during each of the physical scanning time periods TP11-TP13 according to a first clock signal, and one or a plurality of virtual gate lines are driven during each of the virtual scanning time periods TP21-TP22 according to a second clock signal.

To explain in detail, the high voltage level of the detection driving signal DTY1 corresponds to the physical scanning time periods TP11-TP13, and the high voltage level of the detection driving signal DTY2 corresponds to the virtual scanning time periods TP21-TP22. When the detection driving signal DTY1 is at a high voltage level, it indicates that the display operation is performed in a normal manner, and the first clock signal is correspondingly supplied to perform a driving operation of the physical gate lines. Besides, when the detection driving signal DTY2 is at a high voltage level (the detection driving signal DTY1 is at a low voltage level), the virtual gate lines are driven, and no actual display operation is performed. Therefore, the driving operation of the virtual gate lines is performed by the second clock signal that is different from the first clock signal. It is worth mentioning that the frequency of the second clock signal is lower than the frequency of the first clock signal.

As can be seen from the above description, the frequency of the second clock signal used for driving the virtual gate lines during the virtual scanning time periods TP21 to TP22 is lower than the frequency of the first clock signal used for driving the physical gate lines during the physical scanning periods TP11 to TP13. That is to say, the touch display panel may provide an environment with a relatively high signal to noise ratio during the virtual scanning time periods TP21 to TP22. Therefore, in step S130, a first type touch detection may be performed during the physical scanning time periods TP11 to TP13, and a second type touch detection may be performed during the virtual scanning time periods TP21 to TP22, wherein the first type touch detection may be a general finger touch detection that does not require a high signal to noise ratio environment, while the second type touch detection may require a high signal to noise ratio environment, such as a stylus touch detection.

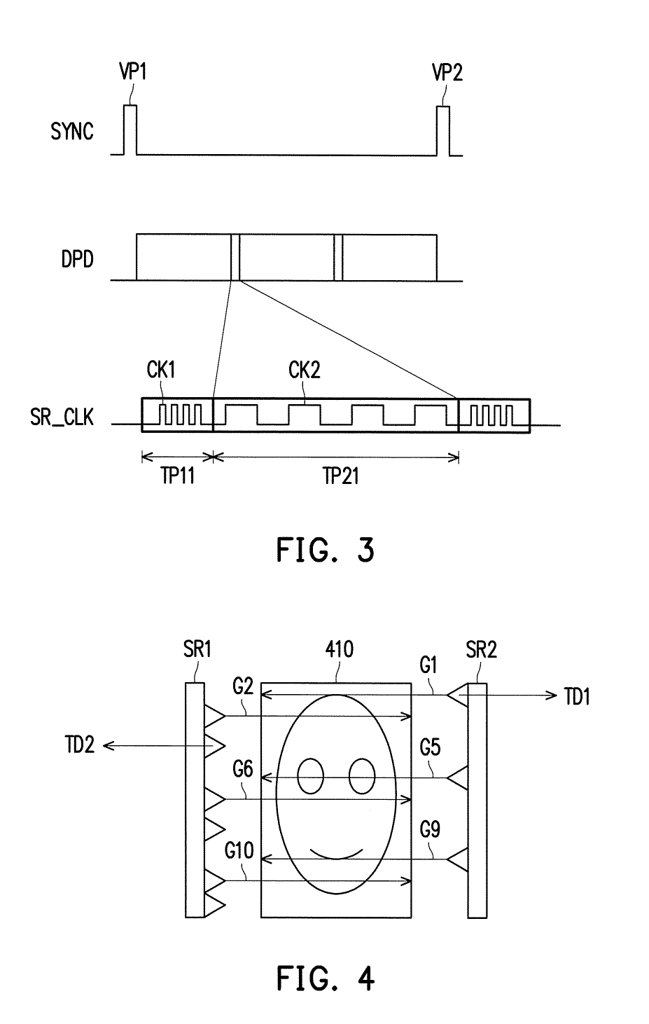

Referring to FIG. 3, which illustrates time sequence of a driving signal according to an embodiment of the invention, the display driving signal DPD is locally amplified, and a scanning operation is performed on the physical gate lines by using the first clock signal CK1 at a higher frequency during the physical scanning time period TP11. In contrast, a scanning operation may be performed on the virtual gate lines by using the second clock signal CK2 with a lower frequency during the virtual scanning time period TP21, thereby reducing noise and providing a better signal to noise ratio environment.

It is worth noting that the frequency and the number of cycles of the supplied second clock signal CK2 may be dynamically adjusted during the virtual scanning time period TP21, wherein a length of time of the virtual scanning time period TP21 may be equal to a product obtained by multiplying the number of cycles of the second clock signal CK2 by the number of the second clock signals CK2.

The length of time of the virtual scanning time period TP21, the frequency of the second clock signal CK2, and the number of cycles of the second clock signal CK2 during the virtual scanning time period TP21 may be determined in accordance with the actual application conditions of the touch display panel. Practically speaking, a memory device (a memory or a temporary register) may be set to store the length of time of the virtual scanning time period TP21, the frequency of the second clock signal CK2, and the number of cycles of the second clock signal CK2 during the virtual scanning time interval TP21 and provide the same to a driving apparatus for reading during the actual operation, and then a driving signal is generated to drive the virtual gate lines.

To explain further, when the specifications of the touch display panel are changed, the length of time of the virtual scanning time period TP21 stored in the memory device, the frequency of the second clock signal CK2, and the number of cycles and other values of the second clock signal CK2 during the virtual scanning time period TP21 may be updated to enable the driving apparatus to generate a proper driving signal to drive the virtual gate lines.

Referring to FIG. 4, which is a schematic diagram illustrating a touch detection action according to an embodiment of the invention, driving apparatuses SR1 and SR2 generate gate driving signals and drive a touch display panel 410 to generate a display image, wherein when the driving apparatuses SR1 and SR2 respectively drive the physical gate lines G2, G6, G10 and G1, G5, G9 to generate a display image, the touch display panel 410 may perform a first type touch detection TD1 that does not require a high signal to noise ratio environment. When the driving apparatuses SR1 and SR2 drive the virtual gate lines (without performing the image display action), the touch display panel 410 may perform a second type touch detection TD2 that requires a high signal to noise ratio environment.

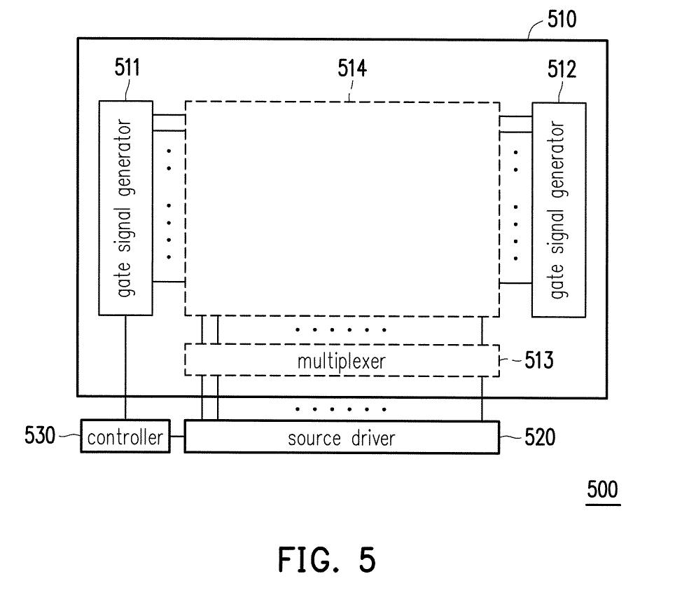

Referring to FIG. 5, which is a schematic diagram illustrating a non in-cell touch display apparatus according to an embodiment of the invention, the non in-cell touch display apparatus 500 includes a touch display panel 510, gate signal generators 511, 512, a source driver 520, a controller 530, and a panel display area 514. The gate signal generators 511 and 512 are coupled to the touch display panel 510 via a plurality of gate lines. The controller 530 is coupled to the gate signal generators 511 and 512 as well as the source driver 520. The controller 530 controls the gate signal generators 511 and 512 as well as the source driver 520 to generate a corresponding driving signal.

The controller 530 divides the vertical scanning time period into one or a plurality of physical scanning time periods and one or a plurality of virtual scanning time periods. The physical gate lines are driven by the gate signal generators 511 and 512 according to a first clock signal during each physical scanning time period, and the virtual gate lines are driven by the gate signal generators 511 and 522 according to a second clock signal during each virtual scanning time period. Besides, the controller 530 performs a first type touch detection during the physical scanning time period and performs a second type touch detection during the virtual scanning time period.

Operation details of the controller 530 have been elaborated in the aforementioned embodiment and therefore will not be further given below.

Incidentally, in some embodiments of the invention, a multiplexer 513 may be configured on the touch display panel 510, wherein the multiplexer 513 is coupled between the source driver 520 and the touch display panel 510.

It is worth noting that the source driver 520 stops providing the display data to the physical display pixels or updating a black screen during the virtual scanning time period, and the multiplexer 513 stops operations during the virtual scanning time period.

Regarding hardware architecture, the controller 530 may be a processor with computing power. Alternatively, the controller 530 may be designed via a hardware description language (HDL) or any other design method of a digital circuit well-known to those skilled in the art. The hardware circuit may be achieved in form of a field programmable gate array (FPGA), a complex programmable logic device (CPLD), or an application-specific integrated circuit (ASIC).

The gate signal generators 511 and 512, the source driver 520, and the multiplexer 513 may be implemented in form of a gate, a source driving circuit, and a multiplexer circuit well-known to those skilled in the art and are not particularly limited in the invention.

To sum up, the driving signal of the virtual gate lines is generated by providing the second clock signal of relatively low frequency during the virtual scanning time period, and the second type touch detection that requires a relatively high signal to noise ratio is executed during the virtual scanning time period. Thereby, different types of touch detection actions may be effectively performed during the vertical scanning time period, thereby improving detection quality.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A touch detection method adapted to a touch display panel, the touch detection method comprising:
dividing a vertical scanning time period into at least one physical scanning time period and at least one virtual scanning time period;
driving at least one physical gate line according to a first clock signal during the at least one physical scanning time period, and driving at least one virtual gate line according to a second clock signal during at least the one virtual scanning time period
operating a first type touch detection during the at least one physical scanning time period, and also operating a second type touch detection during at least one virtual scanning time period.

2. The touch detection method as claimed in claim 1, wherein the at least one physical scanning time period and the at least one virtual scanning time period are alternately arranged in the vertical scanning time period.

3. The touch detection method as claimed in claim 1, wherein a frequency of the first clock signal is higher than a frequency of the second clock signal.

4. The touch detection method as claimed in claim 1, wherein the step of driving the at least one virtual gate line according to the second clock signal during the at least one virtual scanning time period comprises:
setting a frequency of the second clock signal and the number of cycles of the second clock signal during the at least one virtual scanning time period, so as to set a length of time of the at least one virtual scanning time period.

5. The touch detection method as claimed in claim 1, wherein the step of driving the at least one virtual gate line according to the second clock signal during the at least one virtual scanning time period comprises:
stopping providing at least one physical display pixel with at least one display data during the at least one virtual scanning time period or updating a black data.

6. The touch detection method as claimed in claim 1, wherein the step of driving the at least one physical gate line according to the first clock signal during the at least one physical scanning time period comprises:
corresponding to a driven sequence of the at least one physical gate line, providing at least one display data to at least one display pixel.

7. The touch detection method as claimed in claim 1, wherein the first type touch detection is a finger touch detection, while the second type touch detection is a stylus touch detection.

8. A touch display apparatus, comprising:
a touch display panel;
a gate signal generator, coupled to the touch display panel via a plurality of gate lines and driving the plurality of gate lines according to a control signal; and
a controller, coupled to the gate signal generator, wherein the controller is configured to:
divide a vertical scanning time period into at least one physical scanning time period and at least one virtual scanning time period;
drive at least one physical gate line according to a first clock signal during the at least one physical scanning time period, and drive at least one virtual gate line according to a second clock signal during the at least one virtual scanning time period; and
operate a first type touch detection during the at least one physical scanning time period, and also operate a second type touch detection during the at least one virtual scanning time period.

9. The touch display apparatus as claimed in claim 8, wherein the at least one physical scanning time period and the at least one virtual scanning time period are alternately arranged in the vertical scanning time period.

10. The touch display apparatus as claimed in claim 8, wherein a frequency of the first clock signal is higher than a frequency of the second clock signal.

11. The touch display apparatus as claimed in claim 8, wherein by setting a frequency of the second clock signal and a number of cycles of the second clock signal during the at least one virtual scanning time period, the controller sets a length of time of the at least one virtual scanning time period.

12. The touch display apparatus as claimed in claim 8, further comprising:
a source driver, coupled to the controller,
wherein the controller enables the source driver to correspond to a driven sequence of the at least one physical gate line and provides at least one corresponding display pixel with at least one display data during the at least one physical scanning time period.

13. The touch display apparatus as claimed in claim 12, further comprising:
a multiplexer, coupled between the source driver and the touch display panel,
wherein the source driver stops providing the at least one display data to the at least one physical display pixel or updating a black screen during the at least one virtual scanning time period, and the multiplexer stops operating during the at least one virtual scanning time period.

14. The touch display apparatus as claimed in claim 8, wherein the first type touch detection is a finger touch detection, while the second type touch detection is a stylus touch detection.
